(19) United States
(12) Patent Application Publication
(10) Pub. No.: US 2020/0047952 A1
(43) Pub. Date: Feb. 13, 2020

(54) SOFT CONTAINER, SOFT CONTAINER MANUFACTURING APPARATUS, AND SOFT CONTAINER MANUFACTURING METHOD

(71) Applicant: POLYMER SYSTEM CO., LTD., Kanagawa (JP)

(72) Inventor: Yoji TANAKA, Kanagawa (JP)

(21) Appl. No.: 16/499,720

(22) PCT Filed: Mar. 20, 2018
(86) PCT No.: PCT/JP2018/011003

§ 371 Date: Sep. 30, 2019

(51) Int. Cl. B65D 35/10; B65D 35/24; B29D 22/00; B29C 65/04; B29C 65/00

(52) U.S. Cl. CPC B65D 35/10; B65D 35/245; B29K 2023/0625; B29C 65/04; B29C 66/53; B29D 22/003

(57) ABSTRACT

Provided is a soft container in which a tip portion of a body portion can be blocked with one member. The tip portion of a flexible body portion 10 of a soft container 1 is blocked by a tip sheet member 20. The tip sheet member 20 integrally has a circumferential side portion 21, a shoulder portion 22, and a top portion 23. The tip sheet member 20 is constituted by a self-supporting film molded body 28 having a uniform thickness. The tubular circumferential side portion 21 and the body portion 10 are joined to each other. The shoulder portion 22 is reduced in diameter in a tapered shape from the circumferential side portion 21 toward the tip side. The top portion 23 blocks the tip portion of the shoulder portion 22.

### TECHNICAL FIELD

The present invention relates to a soft container, soft container manufacturing, and a soft container manufacturing method, and for example, relates to a soft container, soft container manufacturing, and a soft container manufacturing method suitable for accommodating a fluidic filling material such as an adhesive and a paint.

### BACKGROUND ART

In general, this type of soft container has a flexible body portion and a tip resin member made of a hard resin-based injection molded article (see Patent Documents 1 to 3 and the like). The body portion according to Patent Document 1 has a tubular shape with a resin sheet rounded. A circular lid-shaped tip resin member is provided in the tip portion of the body portion. A discharge port is formed in the middle portion of the tip resin member. A barrier sheet including an aluminum layer is pasted to the inner surface of the tip resin member. The barrier sheet has a flat shape along the inner surface of the tip resin member. The discharge port is blocked by the middle portion of the barrier sheet.

The tip resin members of the soft containers according to Patent Documents 2 and 3 integrally have a tapered shoulder portion and a tubular mouth-neck portion. A barrier sheet including an aluminum layer is pasted to the inner surface of the tip resin member. The barrier sheet has a tapered part along the inner surface of the shoulder portion and a middle planar part. The middle planar part is stretched in the mouth-neck portion, and the mouth-neck portion is blocked as a result.

### CITATION LIST

### Patent Document

Patent Document 1: Japanese Patent No. 5,713,649

Patent Document 2: JP-A-2013-233982

Patent Document 3: JP-A-2011-195144

### SUMMARY OF THE INVENTION

### Technical Problem

The barrier sheets according to Patent Documents 1 to 3 are components attached to a tip resin member made of an injection molded resin and lose support if there is no tip resin member. In other words, two members are necessary in order to block the tip portion of the body portion, one being the tip resin member and the other being the barrier sheet.

In view of the above circumstances, an object of the present invention is to provide a soft container in which the tip portion of a body portion can be blocked with one sheet member.

### Solution to Problem

In order to solve the above problem, a soft container according to the present invention includes a flexible body portion and a tip sheet member blocking a tip portion of the body portion. self-supporting film molded body having a uniform thickness constitutes the tip sheet member and the film molded body integrally has a tubular circumferential side portion joined to the body portion, a shoulder portion reduced in diameter in a tapered shape from the circumferential side portion toward a tip side, and a top portion blocking a tip portion of the shoulder portion.

To be self-supporting means that the film molded body constituting the tip sheet member is self-shape-retaining and does not require a support body to be provided to block the tip portion of the body portion. The film molded body is a film provided with a certain shape.

As a result, the tip portion of the body portion can be blocked with the tip sheet member alone. A support body supporting the tip sheet member is unnecessary, and product cost reduction can be achieved.

When an accommodated object in a fluid state is discharged, a hole is bored in, for example, the top portion. The shoulder portion is tapered, and thus the accommodated object can be smoothly discharged.

Preferably, the circumferential side portion has a tapered shape reduced in diameter more gently than the shoulder portion toward the shoulder portion. As a result, the tip sheet member can be easily removed from a molding apparatus.

Preferably, the top portion has a dome shape convex to the tip side from the shoulder portion. As a result, pressure resistance can be enhanced against an internal pressure attributable to the accommodated object. Designability can be enhanced as well.

Preferably, the shoulder portion and the top portion are smoothly continuous. As a result, it is possible to prevent a large stress from being applied to the part where the shoulder portion and the top portion are continuous.

Preferably, the soft container further includes a bottom sheet member blocking a bottom portion of the body portion and the bottom sheet member has substantially the same shape as the tip sheet member and can be fitted into the tip sheet member.

By boring a hole in the top portion and pushing the bottom sheet member instead of a plunger toward the tip sheet member, it is possible to discharge the accommodated object. In conjunction therewith, the body portion is crushed. Eventually, the bottom sheet member fits into the inner surface side of the tip sheet member. As a result, the accommodated object can be fully taken out. Accordingly, wasting of the accommodated object can be reduced.

Preferably, a tip side part of a sheet constituting the body portion constitutes a tip extending portion by extending to the tip side beyond the tip sheet member and a tip portion of the tip extending portion is sealed.

As a result, the tip sheet member can be sealed in the tip extending portion. Accordingly, it is possible to prevent the tip sheet member from being directly touched by a hand and it is possible to prevent bacteria and dust in the air from adhering to the tip sheet member, and thus hygiene improvement can be achieved. The tip sheet member is covered with the tip extending portion, and thus disfigurement can be prevented even if the tip sheet member has some dents.

Preferably, a tubular or annular discharge port member is joined to an outer surface of a shoulder portion of the tip sheet member and an outer diameter of the discharge port member is smaller than an inner diameter of the tip portion of the body portion.

As a result, the discharge port member is supported by the tip sheet member. The discharge port member does not have to reach the body portion. Accordingly, the discharge port member can be smaller than in a structure in which the discharge port member is a support body of the tip sheet member (Patent Documents 1 to 3 and the like). Accordingly, material cost reduction can be achieved.

A manufacturing apparatus according to the present invention is an apparatus for manufacturing the soft container described above. The apparatus includes a sheet molding unit including a projecting drawing die portion and drawing the tip sheet member from a blank film and a discharge port molding unit facing the drawing die portion, defining a cavity with the tip sheet member on the drawing die portion, and injection-molding the discharge port member by injecting a material of the discharge port member to the cavity.

The tip sheet member and the discharge port member can be manufactured by the single apparatus, and manufacturing cost reduction can be achieved.

A manufacturing method according to the present invention is a method for manufacturing the soft container described above. The method includes the steps of: drawing the tip sheet member from a blank film by a sheet molding unit; and injecting a material of the discharge port member to a cavity defined between the tip sheet member held by the sheet molding unit and a discharge port molding unit facing a tip side of the tip sheet member.

The tip sheet member and the discharge port member can be manufactured almost simultaneously, and manufacturing cost reduction can be achieved.

Preferably, the tip portion of the body portion is overlapped and joined to the circumferential side portion of the tip sheet member. When the circumferential side portion of the tip sheet member and the tip portion of the body portion are overlapped with each other and there is a clearance between the two, a gap may be formed between the two even after the joining. If the clearance is eliminated, overlapping of the two is not easy.

In this regard, the present invention provides a soft container manufacturing apparatus for joining a circumferential side portion of a tip sheet member to the tip portion of the flexible body portion of the soft container. The apparatus includes a core having a tip covered with the tip sheet member and having an outer periphery continuous with the tip and covered with the body portion, the circumferential side portion of the tip sheet member and the tip portion of the body portion overlapping each other on the outer periphery near the tip, core driver increasing a diameter of a core part of the core near the tip during the joining, and a welding head supplying welding energy onto the outer periphery of the core part.

When the core is covered with the tip sheet member and the body portion, the core part near the tip is not increased in diameter. As a result, the core can be easily covered with the tip sheet member and the body portion. Preferably, the two can be easily overlapped by clearance setting between the circumferential side portion of the tip sheet member and the tip portion of the body portion.

After the covering, the core driver increases the diameter of the core part near the tip. Therefore, the core part is pressed from an inner circumferential side against the overlapping part between the circumferential side portion of the tip sheet member and the tip portion of the body portion. As a result, the clearance can be eliminated. In other words, it is possible to prevent a gap from being formed between the circumferential side portion of the tip sheet member and the tip portion of the body portion. In this state, welding energy is supplied from the welding head to the overlapping part between the circumferential side portion of the tip sheet member and the tip portion of the body portion on the outer periphery of the core part. As a result, the circumferential side portion of the tip sheet member and the tip portion of the body portion can be welded and joined without a gap.

Subsequently, the core part is reduced in diameter, and the soft container including the tip sheet member and the body portion is removed from the core.

Preferably, the welding head is a high-frequency welding head including a high-frequency welding coil.

Preferably, the core part has a plurality of inner circumferential pressing members disposed so as to be separated in a circumferential direction and the core driver advances and retracts the plurality of inner circumferential pressing members in a radial direction of the core.

During the joining, the core driver moves the inner circumferential pressing member forward radially outward. As a result, the diameter of the core part increases, and the tip sheet member and the body portion are firmly joined.

After the joining, the inner circumferential pressing member is retracted radially inward by the core driver. As a result, the diameter of the core part is reduced, and the soft container can be removed from the core.

Preferably, the core driver advances and retracts the plurality of inner circumferential pressing members synchronously with each other.

Preferably, the core driver is provided with a drive shaft disposed on the axis of the core, a drive unit causing the drive shaft to slide between advanced and retracted positions along the axis, a cam mechanism provided between the drive shaft and the inner circumferential pressing member, and inner circumferential urging means for urging the inner circumferential pressing member in a diameter-decreasing direction, the inner circumferential pressing member is advanced radially outward by the cam mechanism when the drive shaft is slid to the advanced position, and the inner circumferential pressing member is retracted radially inward by the inner circumferential urging means when the drive shaft is slid to the retracted position.

Preferably, as the cam mechanism, a convex cam surface such as a tapered taper is formed in, for example, the tip portion of the drive shaft and a concave cam surface abutting against the tapered portion is formed in the inner surface of the inner circumferential pressing member.

Preferably, the soft container manufacturing apparatus for the joining further includes an outer circumferential pressing member surrounding the outer periphery of the core part.

As a result, the overlapping part between the tip sheet member and the body portion can be sandwiched between the core part and the outer circumferential pressing member. Therefore, it is possible to reliably prevent gap formation between the tip sheet member and the body portion, and it is possible to firmly join the two. Further, the outer diameter of the soft container is defined by the outer circumferential pressing member, and thus dimensional accuracy enhancement can be achieved. Especially, it is possible to stabilize the diameter dimension of the overlapping part between the tip sheet member and the body portion.

The core part may be surrounded by the single annular outer circumferential pressing member or a plurality of outer circumferential pressing members with each other are annularly disposed around the core part, and thus the core part may be surrounded by the plurality of outer circumferential pressing members.

Preferably, the plurality of the outer circumferential pressing members are capable of advancing and retracting in the radial direction of the core part.

Preferably, a projection extending in the circumferential direction is formed on a surface (inside surface) of the outer circumferential pressing member facing the core part.

The projection crosses the envelope pasting portion or the butt-seamed portion of the body portion, and thus one place of a pasting portion inner gap extending in an elongated shape in the longitudinal direction of the envelope pasting portion or the butt-seamed portion can be locally crushed. Further, the place can be welded and blocked. As a result, it is possible to prevent the inner space of the soft container from communicating with the outside via the pasting portion inner gap. As a result, it is possible to prevent contents from leaking out through the pasting portion inner gap and outside air from entering the soft container through the pasting portion inner gap.

At the least, the projection may be provided at the part of the inside surface of the outer circumferential pressing member that faces the envelope pasting portion or the butt-seamed portion and around that part.

### Advantageous Effects of the Invention

With the present invention, the tip portion of the body portion of a soft container can be blocked by one tip sheet member.

### BRIEF DESCRIPTION OF THE DRAWINGS

FIG. 1(a), which is a cross-sectional view taken along line Ia-Ia of FIG. 1(b), illustrates a soft container according to a first embodiment of the present invention in a state where the container is filled with an accommodated object. FIG. 1(b) is a cross-sectional view of the soft container taken along line Ib-Ib of FIG. 1 (a). FIG. 1(c) is a perspective view of the soft container that is yet to be filled with the accommodated object.

FIG. 2(a) is an enlarged cross-sectional view illustrating the tip side part of the soft container. FIG. 2(b) is a cross-sectional view in which a circle portion IIb of FIG. 2 (a) is further enlarged.

FIG. 3 (a) is a cross-sectional view in which a molding apparatus for a tip sheet member and a discharge port member of the soft container is illustrated in a set state of a blank film for the tip sheet member. FIG. 3 (b) is a cross-sectional view in which the molding apparatus is illustrated in a tip sheet member drawing state. FIG. 3(c) is a cross-sectional view in which the molding apparatus is illustrated in a discharge port member injection molding state.

FIG. 4(a) is a front view illustrating a stage prior to high-frequency welding on the tip sheet member and a body portion. FIG. 4 (b) is a front view illustrating a process in which high-frequency welding is performed on the tip sheet member and the body portion.

FIG. 5 is an enlarged cross-sectional view of the tip side part of a soft container according to a second embodiment of the present invention.

FIG. 6 (a) is a cross-sectional view illustrating a state where a plurality of the soft containers according to the second embodiment are bundled. FIG. 6 (b) is an enlarged cross-sectional view of a circle portion VIb of FIG. 6 (a).

FIG. 7(a) is an enlarged cross-sectional view of the tip side part of a soft container according to a third embodiment of the present invention. FIG. 7(b) is a plan view of the discharge port member of the soft container of the third embodiment.

FIG. 8 (a) is an enlarged cross-sectional view illustrating the bottom side part of a soft container of a fourth embodiment of the present invention in a State where the container is already filled with an accommodated object. FIG. 8(b) is a cross-sectional view in which a circle portion VIIIb of FIG. 8(a) is further enlarged.

FIG. 9 is a cross-sectional view in which the tip part of the soft container according to the fourth embodiment is illustrated in a state where the accommodated object is almost fully taken out.

FIG. 10 (a), which is a cross-sectional view taken along line Xa-Xa of FIG. 10 (b), illustrates a soft container according to a fifth embodiment of the present invention in a state where the container is filled with an accommodated object. FIG. 10(b) is a cross-sectional view of the soft container taken along line Xb-Xb of FIG. 10(a).

FIG. 11 (a) is a cross-sectional view in which the tip side part of the soft container according to the fifth embodiment is illustrated in an opening state. FIG. 11(b) is a cross-sectional view in which the tip side part of the soft container according to the fifth embodiment is illustrated in an open and stored state.

FIG. 12 is a longitudinal cross-sectional view in which a high-frequency welding device (soft container manufacturing apparatus) according to a sixth embodiment of the present invention is seen from a vertical cross section including a cross section taken along line XII-XII of FIG. 13.

FIG. 13 is a plan cross-sectional view of the high-frequency welding device taken along line XIII-XIII of FIG. 12.

FIG. 14 is an enlarged cross-sectional view of a circle portion XIV of FIG. 12.

FIG. 15 (a) is an explanatory cross-sectional view in which the core of the high-frequency welding device is illustrated in a state where a drive shaft is at an advanced position and with the diameter expansion degree of a top core exaggerated. FIG. 15(b) is a cross-sectional view illustrating the core in a state where the drive shaft is at a retracted position.

FIG. 16(a) is an enlarged cross-sectional view of an envelope pasting portion of the soft container in a state where the circumferential side portion of the tip sheet member and the tip portion of the body portion in the soft container are overlapped and yet to be pinched by inner and outer pressing members of the high-frequency welding device. FIG. 16 (b) is a cross-sectional view taken along line XVIb-XVIb of FIG. 14. FIG. 16(c) is an enlarged cross-sectional view taken along line XVIc-XVIc of FIG. 17.

FIG. 17 is a longitudinal cross-sectional view of a soft container.

FIG. 18 is a perspective view of the soft container in which the body portion is formed by envelope pasting.

FIG. 19 is a longitudinal cross-sectional view of the tip part of a soft container according to a modified embodiment in which the body portion is formed by butt-seaming.

FIG. 20(a) is an enlarged cross-sectional view of the root part of the butt-seamed portion of the body portion in a state where the circumferential side portion of the tip sheet member and the tip portion of the body portion according to the modified embodiment are overlapped and yet to be pinched by the inner and outer pressing members. FIG. 20 (b) is an enlarged cross-sectional view taken along line XXb-XXb of FIG. 19.

### MODE FOR CARRYING OUT THE INVENTION

Hereinafter, embodiments of the present invention will be described with reference to accompanying drawings.

### First Embodiment

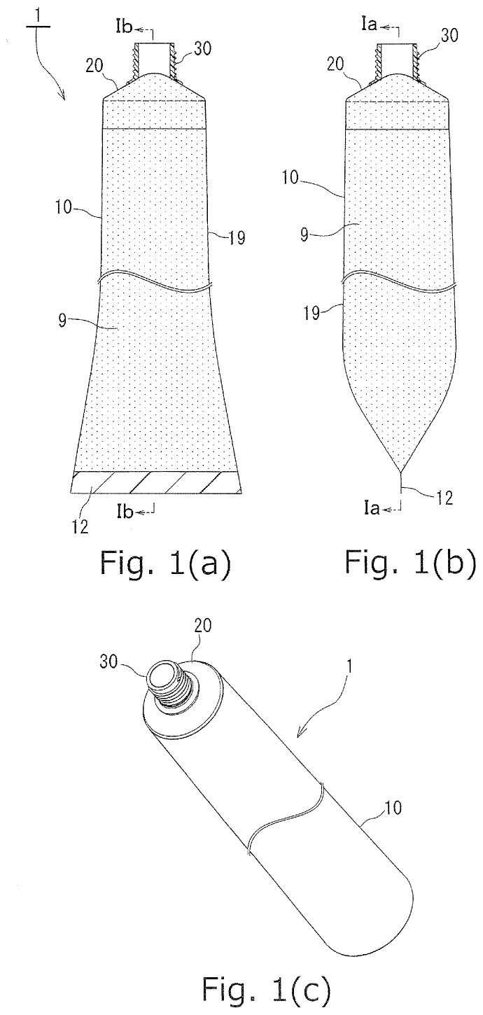

FIGS. 1 to 4 illustrate a first embodiment of the present invention. As illustrated in FIGS. 1(a) to (c), a soft container 1 is provided with a body portion 10, a tip sheet member 20, and a discharge port member 30. An accommodated object 9 (content) of the soft container 1 is, for example, a viscous body or a fluid such as an adhesive, a paint, and a beverage.

The body portion 10 is, for example, one sheet 19 rounded into a tubular shape and envelope-pasted. As illustrated in FIG. 1 (c), the bottom portion of the body portion 10 is open before filling with the accommodated object 9. The body portion 10 is tapered, very gently reduced in diameter from the bottom portion toward the tip. The taper angle of the body portion 10 is, for example, preferably approximately 0.1° to 0.5° and more preferably approximately 0.3° with respect to an axis L₁ of the soft container 1.

As illustrated in FIGS. 1(a) and 1(b), the bottom portion of the body portion 10 is blocked by a heat seal after filling with the accommodated object 9, and then a bottom portion heat seal portion 12 is formed.

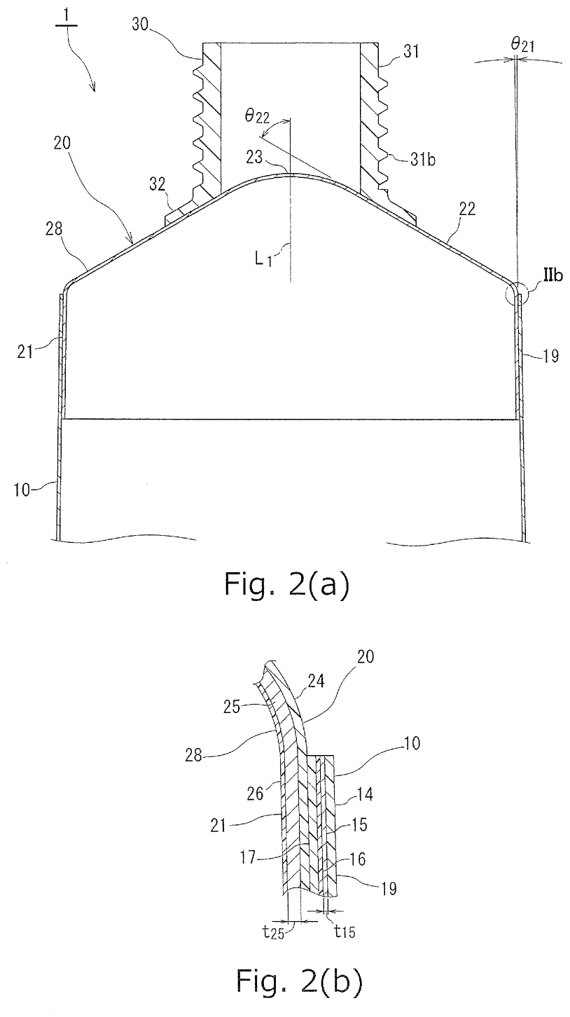

As illustrated in FIG. 2(b), the sheet 19 constituting the body portion 10 is, for example, a laminate structure of four layers (plurality of layers). Both an outermost layer 14 and an innermost layer 17 of the body portion 10 are made of linear low density polyethylene (LLDPE). Envelope pasting is possible as a result. A barrier layer 15 and a resin layer 16 are sandwiched between the outermost layer 14 and the innermost layer 17. The barrier layer 15 is made of a metal such as aluminum, and a thickness t₁₅ of the barrier layer 15 is, for example, approximately 7 μm to 15 μm and preferably approximately 12 μm. As a result, gas barrier properties can be reliably demonstrated and the flexibility of the body portion 10 can be ensured. The resin layer 16 is made of polyethylene terephthalate (PET).

Note that, the number of laminated films of the body portion 10, the thickness of each layer, the material, the seal structure, and the like are not necessarily limited to those described above and can be appropriately modified.

The tip sheet member 20 is provided in the tip portion of the body portion 10. The tip portion of the body portion 10 is blocked by the tip sheet member 20. As illustrated in FIG. 2(a), the tip sheet member 20 integrally has a circumferential side portion 21, a shoulder portion 22, and a top portion 23. The tip sheet member 20 has an axis disposed on the axis L₁ of the soft container 1.

The circumferential side portion 21 has a tubular shape having a circular cross section. Specifically, the circumferential side portion 21 is tapered, very gently reduced in diameter toward the tip side (shoulder portion 22 side). A taper angle θ21 of the circumferential side portion 21 matches the taper angle of the body portion 10 and is, for example, preferably approximately 0.1° to 0.5° and more preferably approximately 0.3° with respect to the axis L₁ of the soft container 1.

The tip portion of the body portion 10 is joined to the circumferential side portion 21. Specifically, the tip portion of the body portion 10 covers the outer circumferential surface of the circumferential side portion 21, and the body portion 10 and the circumferential side portion 21 are welded. Although high-frequency welding is used here as a welding method, welding methods are not necessarily limited thereto, and other welding methods such as ultrasonic welding and thermal welding may be used.

The shoulder portion 22 is connected to the tip portion of the circumferential side portion 21. The shoulder portion 22 has a tapered shape (conical surface shape), reduced in diameter from the circumferential side portion 21 toward the tip side (upper side in FIG. 2 a)). A taper ƒ₂₂ angle of the shoulder portion 22 is sufficiently larger than the taper angle θ₂₁ of the circumferential side portion 21 (θ₂₂>θ₂₁) and, for example, approximately 45° to 75° and preferably approximately 60° with respect to the axis L₁. In other words, the circumferential side portion 21 is a gently tapered portion and the shoulder portion 22 is a steeply tapered portion.

The tip portion (middle portion) of the shoulder portion 22 is blocked by the top portion 23. The top portion 23 is smoothly continuous with the shoulder portion 22 and has a dome shape (partially spherical shape) convex to the tip side.

A film molded body 28 constitutes the tip sheet member 20. The film molded body 28 has a uniform (even) thickness as a whole and is self-supporting. To be self-supporting means that the film molded body 28 is self-shape-retaining and does not require a support body such as a hard injection molding resin to be provided in the tip portion of the body portion 10. To be self-shape-retaining means that the film molded body 28 retains its own shape without any aid and the shape does not collapse under its own weight or some external force.

As illustrated in FIG. 2(b), the film molded body 28, the tip sheet member 20 in turn, has, for example, a three-layer laminate structure. An outer layer 24 of the tip sheet member 20 is made of linear low density polyethylene (LLDPE) and an inner layer 26 is made of polyethylene terephthalate (PET). The outer layer 24 faces the outside of the soft container 1 and the inner layer 26 faces the inside of the soft container 1. A barrier layer 25 is sandwiched between the outer layer 24 and the inner layer 26. The barrier layer 25 is made of a metal such as aluminum and has gas barrier properties. A thickness t₂₅ of the barrier layer 25 is larger than the thickness t₁₅ of the barrier layer 15 (t₂₅>t₁₅). For example, t₂₅ is approximately 30 μm to 50 μm and preferably approximately 40 μm. Since the barrier layer 25 is relatively thick, the film molded body 28, the tip sheet member 20 in turn, is harder than the body portion 10. Self-shape-retaining or self-supporting properties are given as a result.

Note that, the number of laminated films of the film molded body 28, the tip sheet member 20 in turn, the thickness of each layer, the material, and the like are not necessarily limited to those described above and can be appropriately modified.

As illustrated in FIG. 2(a), the discharge port member 30 is provided on the outer surface of the tip sheet member 20. The material of the discharge port member 30 is a hard resin such as polyethylene (PE) and polypropylene (PP). The discharge port member 30 integrally includes a discharge port portion 31 and a flange portion 32. The discharge port portion 31 has a tubular shape and protrudes from the tip sheet member 20 to the tip side (upper side in FIG. 2(a)). The discharge port portion 31 has an axis matching the axis L₁ of the soft container 1. A male screw portion 31b is formed on the outer circumferential surface of the discharge port portion 31. Although not illustrated, a cap or a nozzle that has a female screw is attached to the discharge port portion 31.

The flange portion 32 is formed in the end portion of the discharge port portion 31 on the base end side (side facing the tip sheet member 20). The flange portion 32 protrudes radially outward from the outer periphery of the discharge port portion 31 and is annular over the entire circumference of the discharge port portion 31. The bottom surface of the flange portion 32 is joined to the outer surface of the shoulder portion 22. As a result, the discharge port member 30 is supported by the tip sheet member 20. In other words, the tip sheet member 20, the film molded body 28 in turn, has not only self-supporting properties but also strength or firmness sufficient to support another member (discharge port member 30).

The outer diameter of the flange portion 32, the outer diameter of the discharge port member 30 in turn, is smaller than the inner diameter of the tip portion of the body portion 10. The discharge port member 30 is not in direct contact with the body portion 10. The discharge port member 30 is connected to the body portion 10 via the tip sheet member 20.

The opening of the discharge port portion 31 on the base end side (lower side in FIG. 2(a)) is blocked by the top portion 23. The dome-shaped top portion 23 is slightly in the discharge port portion 31.

The soft container 1 is manufactured as follows.

<Molding Apparatus 50 (Soft Container Manufacturing Apparatus)>

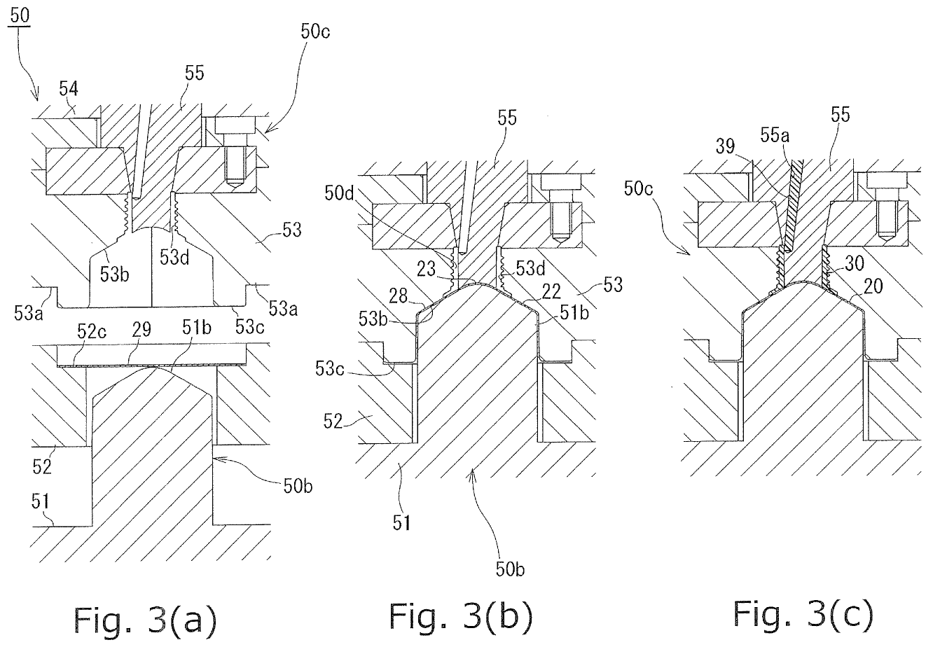

As illustrated in FIG. 3, the tip sheet member 20 and the discharge port member 30 in the soft container 1 are manufactured by a molding apparatus 50 (soft container manufacturing apparatus). As illustrated in FIG. 3 (a), the molding apparatus 50 includes a first mold 51, a second mold 52, and a third mold 53. These molds 51 to 53 are sequentially disposed from bottom to top.

The first mold 51 has a projecting drawing die portion 51b. The tip portion (upper end portion) of the drawing die portion 51b has a conical surface shape matching the shape of the tip sheet member 20. A sheet set portion 52c including an annular recessed portion is formed in the second mold 52. The first mold 51 and the second mold 52 mainly constitute a sheet molding unit 50b.

The third mold 53 has a conical recessed surface-shaped drawing receiving portion 53b and a threaded cylindrical recessed surface-shaped injection mold portion 53d. The injection mold portion 53d is provided in the middle portion of the drawing receiving portion 53b.

A top plate 54 is disposed on the top of the third mold 53. An injection nozzle 55 is provided in the middle portion of the top plate 54. The injection nozzle 55 is inserted in the cylindrical recessed surface-shaped injection mold portion 53d.

The third mold 53 and the injection nozzle 55 mainly constitute a discharge port molding unit 50c. The discharge port molding unit 50c is disposed to face the tip side (upper side) of the sheet molding unit 50b.

Note that, the third mold 53 is divided into a plurality of pieces 53a (one left piece 53a and one right piece 53a in FIG. 3). The third mold 53 can be opened and closed by these pieces 53a being separated from or approaching each other around the injection nozzle 55.

<Drawing Process>

As illustrated in FIG. 3(a), a disk-shaped blank film 29 (pre-molding film) to be the tip sheet member 20 is set in the sheet set portion 52c. The second mold 52 and the third mold 53 are brought close to each other and the outer peripheral portion of the blank film 29 is pressed by a sheet pressing portion 53c of the third mold 53.

Subsequently, as illustrated in FIG. 3(b), the first mold 51 and the second mold 52 are brought close to each other and clamped. As a result of the clamping, the drawing die portion 51b protrudes from the center hole of the sheet set portion 52c and enters the drawing receiving portion 53b while drawing and deforming the blank film 29. As a result, the film molded body 28, the tip sheet member 20 in turn, is drawn from the blank film 29 by the sheet molding unit 50b.

Breakage of the barrier layer 25 during drawing can be prevented by the barrier layer 25 being thicker than the barrier layer 15 of the body portion 10 (by t₂₅ being preferably approximately 30 μm to 50 μm and more preferably approximately 40 μm). Incidentally, the barrier layer 25 is likely to break during drawing if the thickness of the barrier layer 25 would be approximately equal to the thickness of the barrier layer 15 (if, for example, t₂₅ would be approximately 10 μm to 15 μm).

<Injection Molding Process>

Simultaneously with the drawing of the tip sheet member 20, a cavity 50d is defined between the tip sheet member 20 and the inner surface of the injection mold portion 53d and the outer circumferential surface of the injection nozzle 55 on the upper side (tip side) of the tip sheet member 20. Incidentally, the drawing receiving portion 53b hits the shoulder portion 22 and the lower end surface of the injection nozzle 55 hits the top portion 23.

Subsequently, as illustrated in FIG. 3(c), a molten resin 39 (material of the discharge port member 30) is injected to the cavity 50d from an injection path 55a of the injection nozzle 55 with the tip sheet member 20 held by the sheet molding unit 50b. As a result, the discharge port member 30 can be injection-molded simultaneously with or immediately after the drawing of the tip sheet member 20. In addition, simultaneously with the injection molding, the discharge port member 30 can be integrally joined to the tip sheet member 20 by the adhesiveness of the molten resin 39.

Subsequently, the molds 51 to 53 are separated from each other, the clamping is released, and the tip sheet member 20 that has the discharge port member 30 is demolded. The circumferential side portion 21 is gently tapered, and thus the tip sheet member 20 can be easily die-cut.

The tip sheet member 20 and the discharge port member 30 are manufactured as a result. The tip sheet member 20 and the discharge port member 30 can be efficiently manufactured by the single molding apparatus 50, and manufacturing cost reduction can be achieved.

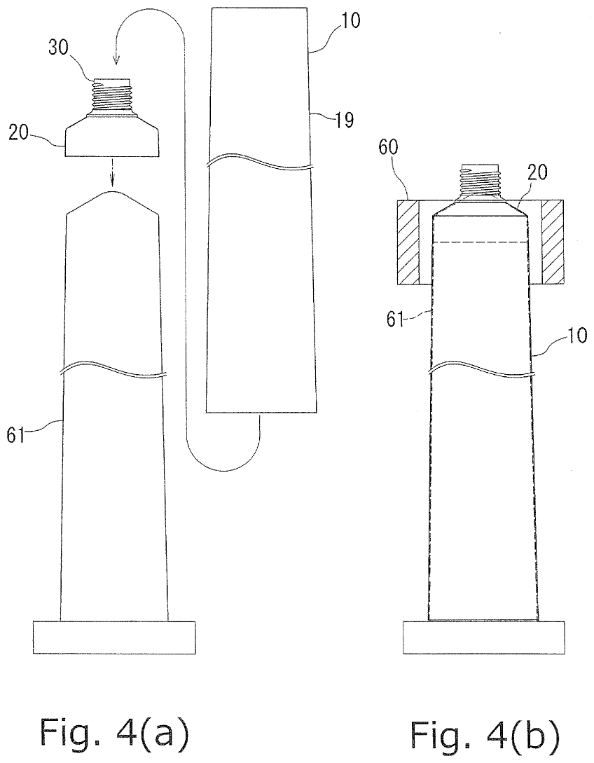

Next, as illustrated in FIG. 4, the separately prepared body portion 10 and tip sheet member 20 having the discharge port member 30 are joined.

Specifically, as illustrated in FIG. 4(a), a mandrel 61 is prepared as a jig for joining. The mandrel 61 has a columnar shape and is gently reduced in diameter toward the tip side (upper side).

The tip portion (upper end portion) of the mandrel 61 is covered with the tip sheet member 20 (that has the discharge port member 30).

Next, the body portion 10 covers the outer periphery of the mandrel 61 from above. As a result, the tip portion (upper end portion) of the body portion 10 covers the outer peripheral portion of the circumferential side portion 21. By both the body portion 10 and the circumferential side portion 21 being tapered, the body portion 10 can be brought into tight contact over the entire circumference of the circumferential side portion 21.

Next, as illustrated in FIG. 4(b), an annular high-frequency welding device 60 is set on the outside of the tip portion of the mandrel 61, and high-frequency welding is performed on the tip portion of the body portion 10 and the circumferential side portion 21.

Subsequently, the soft container 1 is removed from the mandrel 61.

As a result, it is possible to manufacture the soft container 1 (that is yet to be filled with the accommodated object 9).

In the soft container 1, the tip portion of the body portion 10 can be blocked with the tip sheet member 20 alone. A support body supporting the tip sheet member 20 is unnecessary, and product cost reduction can be achieved.

The flange portion 32 of the discharge port member 30 does not have to reach the body portion 10, and the discharge port member 30 can be smaller than in a structure in which the discharge port member 30 would be a support body of the tip sheet member 20 (Patent Documents 1 to 3 and the like). Accordingly, material cost reduction can be achieved.

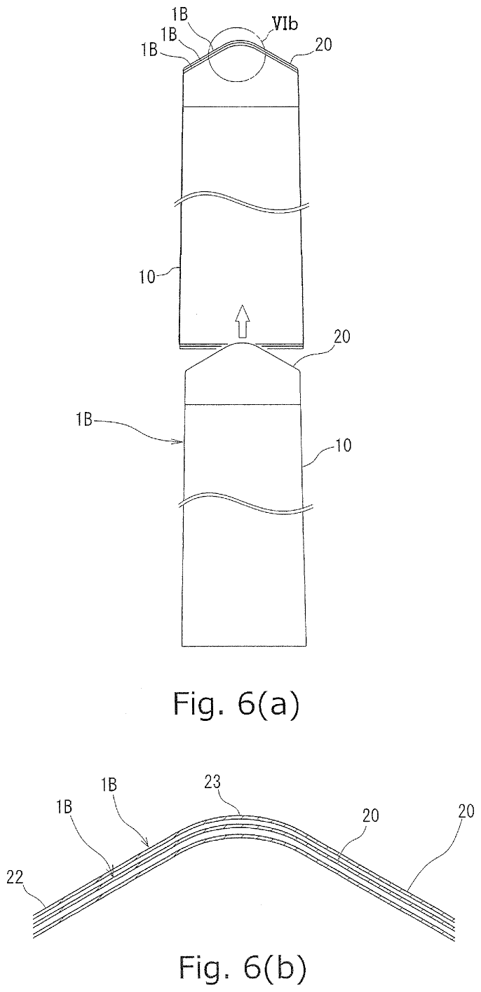

The bottom portion of the soft container 1 is open when the soft container 1 is yet to be filled with the accommodated object 9. Another soft container 1 can be inserted inside from this bottom portion opening. The body portion 10 is slightly tapered, and thus the inserting operation can be facilitated. Further, compactness can be achieved when a plurality of the soft containers 1, 1, . . . are sequentially inserted in a row and bundled (See FIG. 6(a)). As a result, a storage space for the plurality of soft containers 1, 1, . . . can be smaller and transport and the like can be efficient.

The soft container 1 is filled with the accommodated object 9 from the bottom portion of the soft container 1. After the filling, the bottom portion of the soft container 1 is heat-sealed. The soft container 1 is sealed as a result. The barrier layer 15 of the body portion 10 and the barrier layer 25 of the tip sheet member 20 are capable of hindering external air infiltration into the soft container 1. As a result, the quality of the accommodated object 9 can be maintained for a long period.

The shoulder portion 22 and the top portion 23 are smoothly continuous, and thus it is possible to prevent a large stress from being applied to the part where the shoulder portion 22 and the top portion 23 are continuous. In addition, by the top portion 23 having a dome shape, pressure resistance can be enhanced against an internal pressure attributable to the accommodated object 9. Further, designability can be enhanced as well.

When the accommodated object 9 is used, a hole is bored in, for example, the top portion 23. A nozzle (not illustrated) to be mounted on the male screw portion 31b may be sharpened, the tip of the nozzle may be inserted into the discharge port member 30, and the top portion 23 may be pierced for opening. By the thickness of the barrier layer 25 being approximately 30 to 50 μm and preferably approximately 40 μm, the opening operation can be performed without hindrance.

The open soft container 1 is set in, for example, a discharge gun and the body portion 10 is axially crushed with a plunger of the discharge gun. Then, the accommodated object 9 is discharged from the discharge port member 30 through the open portion of the top portion 23. The accommodated object 9 can be smoothly discharged since the shoulder portion 22 is tapered.

Next, the other embodiments of the present invention will be described. In the following embodiments, the same reference numerals are attached to the configurations that overlap with those of the above-described embodiment in the drawings, and description thereof will be appropriately omitted.

### Second Embodiment

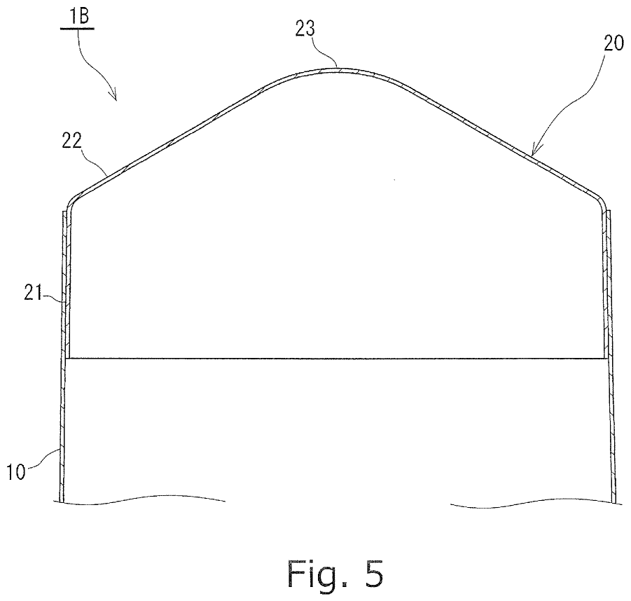

FIG. 5 illustrates a second embodiment of the present invention. As illustrated in FIG. 5, a soft container 1B of the second embodiment does not have the discharge port member 30. The entire outer surfaces of the shoulder portion 22 and the top portion 23 of the tip sheet member 20 face the outside of the soft container n.

As illustrated in FIG. 6, in a case where another soft container 1B is inserted inward from the open portion of the bottom portion (lower end in FIG. 6(a)) of the soft container 1B in the second embodiment, the soft container 1B can be deeply inserted until the tip sheet members 20 and 20 of the soft containers 1B and 1B substantially overlap each other. Accordingly, by a plurality of the soft containers 1B, 1B, . . . being sequentially inserted in a row and bundled, the plurality of soft containers 1B, 1B, . . . can be stored, transported, and the like in a more compact state.

### Third Embodiment

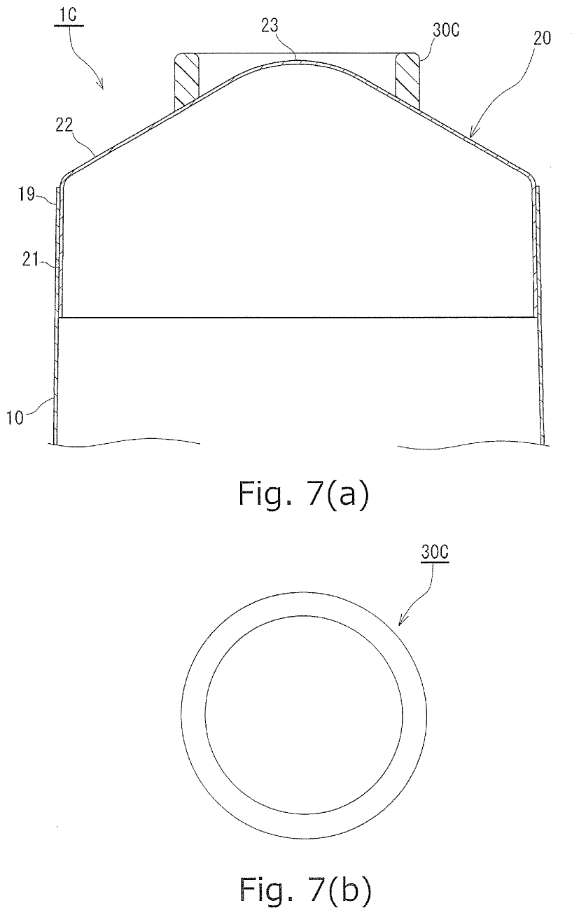

FIG. 7 illustrates a third embodiment of the present invention. As illustrated in FIG. 7(b), the tip sheet member 20 of a soft container 10 of the third embodiment has an annular (ring-shaped) discharge port member 30C instead of the discharge port member 30 of the first embodiment (FIG. 1). As illustrated in FIG. 7 (a), the discharge port member 30C is supported by the tip sheet member 20 by being joined to the outer surface of the shoulder portion 22. The outer diameter of the discharge port member 30C is sufficiently smaller than the inner diameter of the tip portion of the body portion 10. The discharge port member 300 is not in direct contact with the body portion 10. In addition, the height (vertical-direction dimension in FIG. 7(a)) of the discharge port member 30C is sufficiently smaller than that of the discharge port member 30 of the first embodiment (FIG. 2(a)). Although not illustrated, a nozzle of a discharge gun can be connected to the discharge port member 30C.

The tip sheet member 20 that has the discharge port member 30C can be manufactured by the same method as in the first embodiment.

### Fourth Embodiment

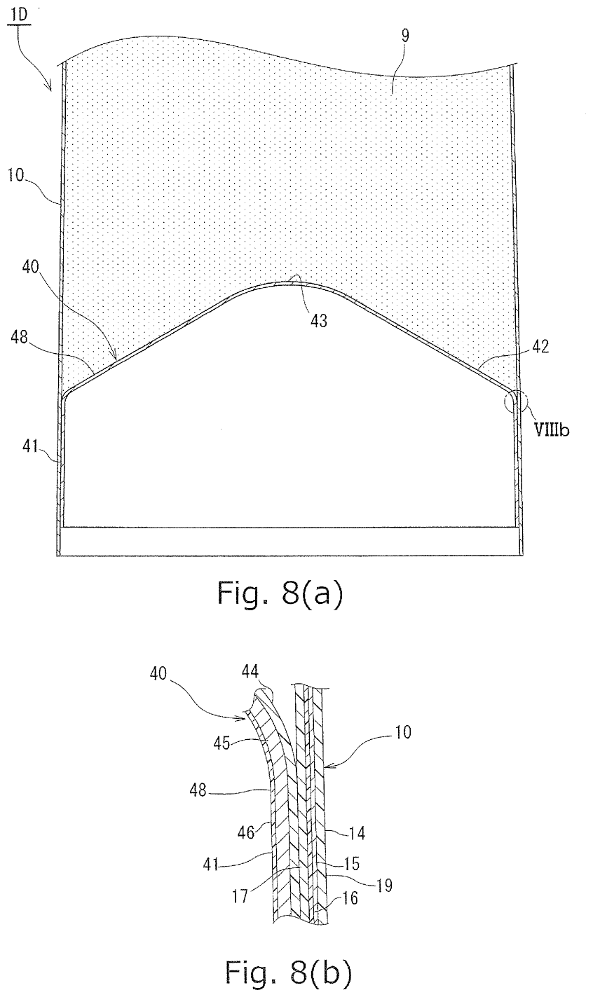

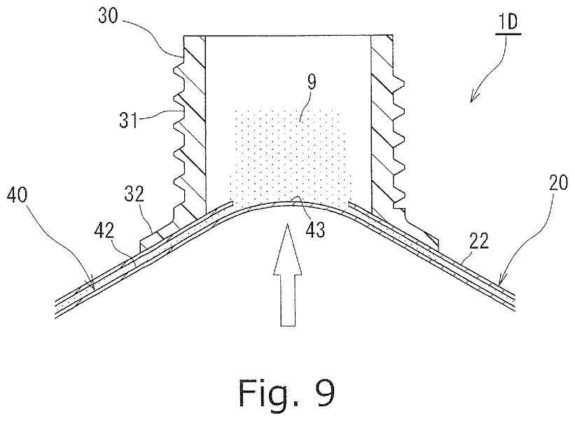

FIGS. 8 to 9 illustrate a fourth embodiment of the present invention. As illustrated in FIG. 8(a), in a soft container 1D of the fourth embodiment, a bottom sheet member 40 is provided in the bottom portion of the body portion 10 subsequent to filling with the accommodated object 9. The bottom portion of the body portion 10 is blocked by the bottom sheet member 40. The bottom sheet member 40 has substantially the same shape as the tip sheet member 20. In other words, the bottom sheet member 40 integrally has a gently tapered circumferential side portion 41, a steeply tapered shoulder portion 42, and a dome-shaped top portion 43. Further, a second film molded body 48 constitutes the bottom sheet member 40. The second film molded body 48 has a uniform (even) thickness as a whole and is self-supporting. As is the case with the film molded body 28, the second film molded body 48 can be prepared by drawing.

Further, as illustrated in FIG. 8(b), the film molded body 48, the bottom sheet member 40 in turn, has the same laminate structure as the tip sheet member 20. In other words, the bottom sheet member 40 includes an outer layer 44 made of linear low density polyethylene (LLDPE), an inner layer 46 made of polyethylene terephthalate (PET), and an intermediate barrier layer 45 made of aluminum. The thickness and the like of the barrier layer 45 are the same as those of the barrier layer 25.

Note that, the number of laminated films of the bottom sheet member 40, the thickness of each layer, the material, and the like are not necessarily limited to the above and can be appropriately modified. In addition, the shape and the size of the bottom sheet member 40 may be somewhat different from those of the tip sheet member 20.

The bottom sheet member 40 is joined to the bottom portion of the body portion 10. Specifically, the bottom portion of the body portion 10 covers the outer circumferential surface of the circumferential side portion 41, and the body portion 10 and the circumferential side portion 41 are welded. Although high-frequency welding is used here as a welding method, welding methods are not necessarily limited thereto, and other welding methods such as ultrasonic welding and thermal welding may be used.

The bottom sheet member 40 is a substitute for a plunger. In other words, as illustrated in FIG. 9, the accommodated object 9 can be discharged when a hole is bored in the top portion 23 of the tip sheet member 20 and the bottom sheet member 40 is axially pushed toward the tip sheet member 20. The body portion 10 is crushed in conjunction therewith. As illustrated in FIG. 9, eventually, the bottom sheet member 40 fits into the inner surface side of the tip sheet member 20. As a result, the accommodated object 9 can be fully taken out, and wasting of the accommodated object 9 can be reduced.

### Fifth Embodiment

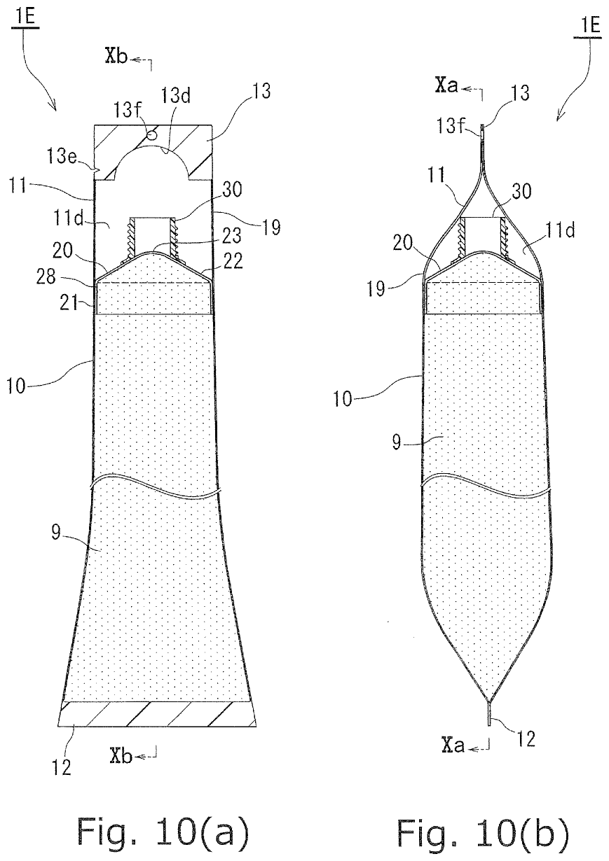

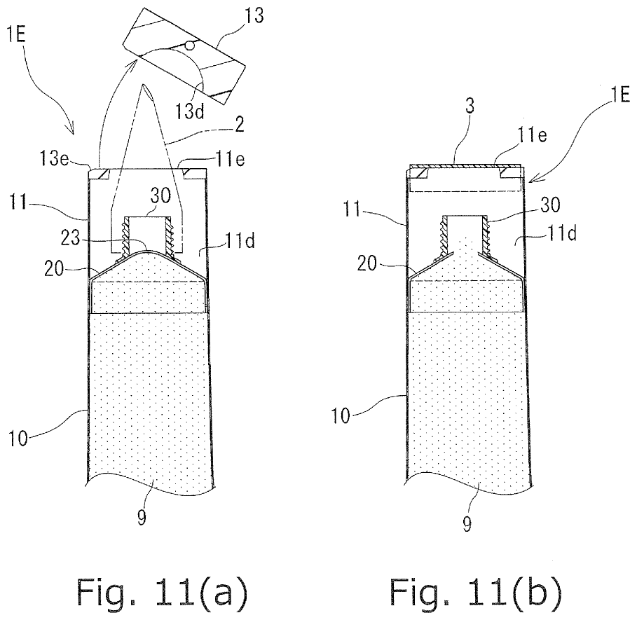

FIGS. 10 and 11 illustrate a fifth embodiment of the present invention. As illustrated in FIGS. 10(a) and 10 (b), in a soft container 1E of the fifth embodiment, the tip side part of the sheet 19 constituting the body portion 10 (upper side part in the drawings) extends to the tip side (upper side in the drawings) beyond the tip sheet member 20 and the discharge port member 30. The tip side part of the sheet 19 constitutes a tip extending portion 11.

The base end portion (lower end portion in the drawings) of the tip extending portion 11 is circular to be along the outer periphery of the tip sheet member 20 and integrally connected to the body portion 10.

The tip portion (upper end portion in the drawings) of the tip extending portion 11 is sealed and forms a sealing portion 13 by one side portion and the other side portion in the circumferential direction overlapping each other and being heat-sealed. An inner space 11d of the tip extending portion 11 between the tip sheet member 20 and the sealing portion 13 is sealed.

As illustrated in FIG. 10(a), a semicircular recessed portion 13d is formed in the bottom side portion (lower side portion in FIG. 10(a)) of the sealing portion 13. The inner space 11d of the tip extending portion 11 is in the semicircular recessed portion 13d.

A notch 13e is formed near the bottom side portion of one side edge (left side edge in FIG. 10(a)) of the sealing portion 13.

Further, a hook hole 13f (eyelet) is formed in the sealing portion 13. By passing a hook or the like through the hook hole 13f, it is possible to suspend and store the soft container 1E.

In the soft container 1E according to the fifth embodiment, the tip sheet member 20 and the discharge port member 30 can be sealed in the tip extending portion 11. Accordingly, during transport, storage, and the like of the soft container 1E, it is possible to prevent the tip sheet member 20 and the discharge port member 30 from being directly touched by a hand and it is possible to prevent bacteria and dust in the air from adhering to the tip sheet member 20 and the discharge port member 30, and thus hygiene improvement can be achieved. This is particularly effective in a case where the accommodated object 9 is an object requiring hygiene control such as a liquid medicine and a food material such as a beverage. Also, it is possible to prevent garbage or the like from entering and accumulating in the discharge port member 30.

In addition, in the soft container 1E, the tip sheet member 20 is covered with the tip extending portion 11, and thus disfigurement can be prevented even if the tip sheet member 20 has some dents.

As illustrated in FIG. 11 (a), when the soft container 1E is used, the sealing portion 13 is cut in the width direction (left-right direction in FIG. 11 (a)) with the notch 13e as a trigger. As a result, the sealing portion 13 on the tip side from the notch 13e can be cut. The tip extending portion 11 on the body portion 10 side from the notch 13e is left. Incidentally, a cut end lie crosses the semicircular recessed portion 13d, and thus the inner space 11d of the tip extending portion 11 is open via the cut end 11e. As indicated by the two-dot chain line in FIG. 11 (a), the base end portion of a nozzle 2 is inserted into the tip extending portion 11 from the cut end lie (opening) and the discharge nozzle 2 is attached to the discharge port member 30. In addition, the top portion 23 of the tip sheet member 20 is opened (see FIG. 11 (b)). As a result, the accommodated object 9 can be discharged from the nozzle 2.

As illustrated in FIG. 11 (b), when the already opened soft container 1E is stored, it is preferable to remove the nozzle 2 and block the cut end 11e with an adhesive tape 3. In this manner, air infiltration into the soft container 1E can be prevented or suppressed and deterioration or degeneration of the accommodated object 9 can be prevented or suppressed.

Also, the tip port of the nozzle 2 may be blocked by film winding or the like with the nozzle 2 attached.

### Sixth Embodiment

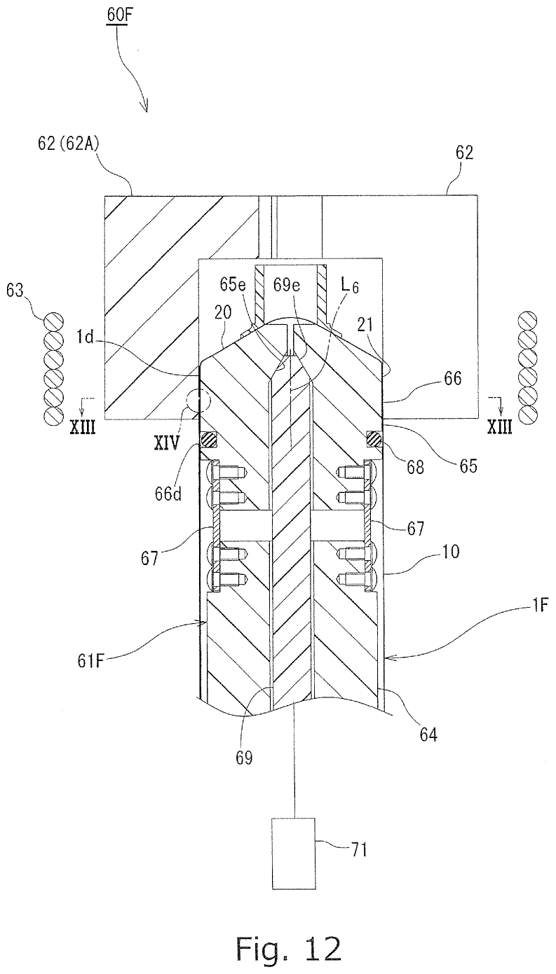

FIGS. 12 to 20 illustrate a sixth embodiment of the present invention.

<Envelope Pasting Soft Container 1F>

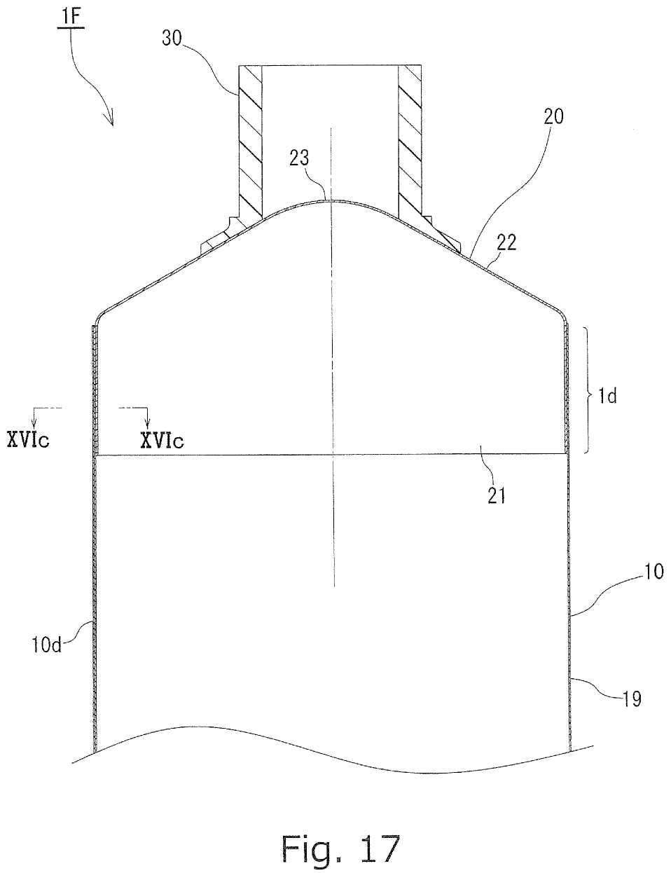

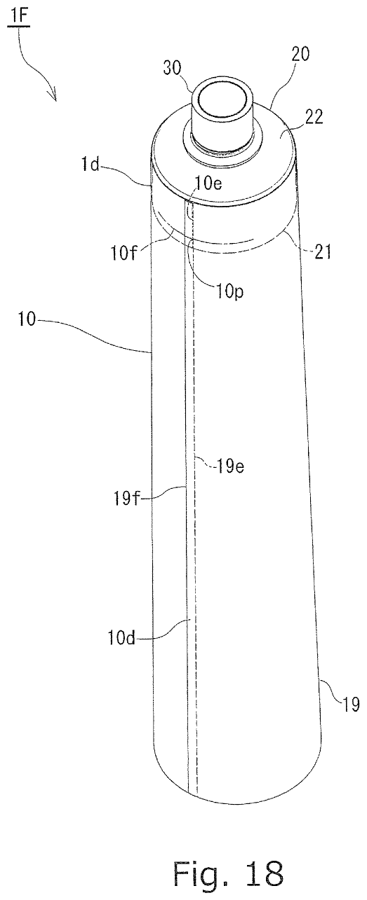

FIGS. 17 and 18 illustrate a soft container 1F in a state where the bottom portion is unsealed (open) and the content is yet to be filled. The soft container 1F is provided with the body portion 10, the tip sheet member 20, and the discharge port member 30. After filling with the content from the bottom portion open portion (lower end in FIG. 18) of the body portion 10, the bottom portion open portion is sealed by a heat seal. The content is, for example, a viscous body or a fluid such as an adhesive, a paint, and a beverage.

The body portion 10 is, for example, one sheet 19 rounded into a tubular shape with both end portions 19e and 19f of the sheet 19 envelope-pasted. An envelope pasting portion 10d is formed in one circumferential place of the body portion 10. The envelope pasting portion 10d linearly extends over the entire longitudinal length of the body portion 10.

Although not illustrated in detail, the sheet 19 is a laminate sheet including a resin layer formed of polyethylene or the like and a metal barrier layer formed of aluminum or the like. Preferably, the body portion 10 is tapered to be very gently reduced in diameter from the bottom portion toward the tip (upper end in FIG. 18). The taper angle of the body portion 10 is preferably approximately 0.1° to 0.5° and more preferably approximately 0.3° with respect to the axis L₁ of the soft container 1F.

The tip sheet member 20 is provided in the tip portion of the body portion 10. The tip portion of the body portion 10 is blocked by the tip sheet member 20. The tip sheet member 20 is formed by drawing of a laminate sheet including a resin layer formed of polyethylene or the like and a metal barrier layer formed of aluminum or the like. The metal barrier layer of the tip sheet member 20 is thicker than the metal barrier layer of the body portion 10. Accordingly, the tip sheet member 20 is harder than the body portion 10 and self-shape-retaining.

As illustrated in FIG. 17, the tip sheet member 20 integrally has the circumferential side portion 21, the shoulder portion 22, and the top portion 23. The circumferential side portion 21 has a substantially cylindrical shape. Preferably, the circumferential side portion 21 has a tapered shape to be very gently reduced in diameter toward the tip side (shoulder portion 22 side). More preferably, the taper angle of the circumferential side portion 21 matches the taper angle of the body portion 10.

The shoulder portion 22 having the shape of a steeply tapered conical surface is connected to the tip portion of the circumferential side portion 21. The tip portion (middle portion) of the shoulder portion 22 is blocked by the top portion 23 having a dome shape or a partially spherical shape.

The tubular discharge port member 30 made of a hard resin such as polyethylene (PE) and polypropylene (PP) is provided on the outer surface of the tip sheet member 20. The bottom portion of the inner passage of the discharge port member 30 is blocked by the top portion 23 of the tip sheet member 20. During use, a hole is bored in the top portion 23, and thus the content (accommodated object) is discharged from the discharge port member 30 as a result.

The tip portion of the body portion 10 overlaps the outer circumferential surface of the circumferential side portion 21 of the tip sheet member 20 in a covering manner, and the tip sheet member 20 and the body portion 10 are joined at the overlapping part 1d.

<High-Frequency Welding Device 60F>

As illustrated in FIG. 12, the tip sheet member 20 and the body portion 10 are joined by a high-frequency welding device 60F (joining device part in the soft container manufacturing apparatus). The high-frequency welding device 60F is provided with a core 61F, an outer circumferential pressing member 62, and a welding head 63.

The core 61F has a base core 64 and a top core 65 (core part near the tip) and vertically extends along an axis L6. The top core 65 is disposed above the base core 64 via a pair of connecting plates 67. Each of the base core 64 and the top core 65 has a cylindrical shape, and the outer circumferential surfaces thereof are tapered to be slightly reduced in diameter upward and match the taper angles of the body portion 10 and the circumferential side portion 21. The tip portion of the top core 65 has a conical shape matching the shoulder portion 22.

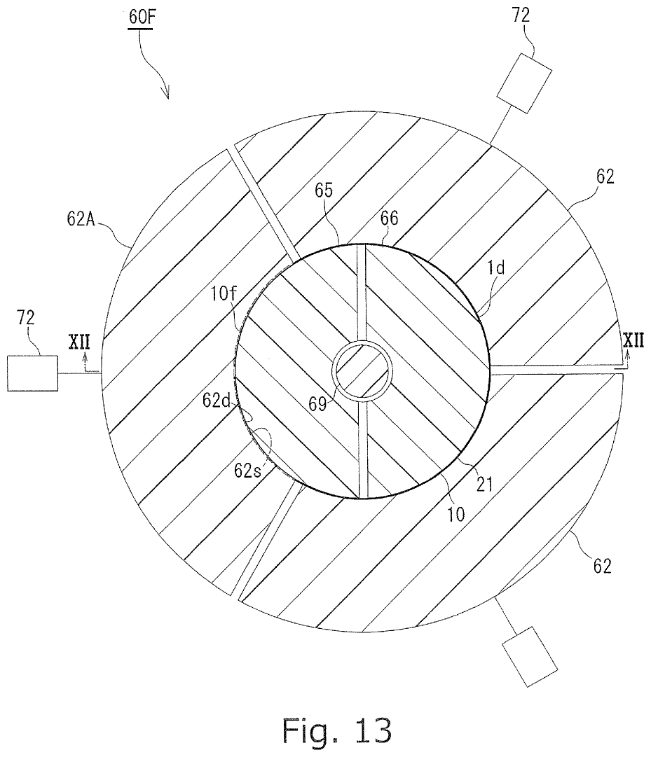

As illustrated in FIGS. 12 and 13, the top core 65 has a half structure having two (a plurality of) inner circumferential pressing members 66. The inner circumferential pressing members 66 are disposed so as to be separated in the circumferential direction so as to face each other across the axis L6. The material of the inner circumferential pressing member 66 is a hard resin. From the viewpoint of heat resistance, insulating properties, and lubricity, the material is preferably polyether ether ketone (PEEK).

As illustrated in FIG. 12, each inner circumferential pressing member 66 and the base core 64 is connected via the connecting plate 67. The connecting plate 67 is made of a metal such as aluminum and steel and is elastically deformable.

An annular elastic member 68 made of rubber is mounted on the outer periphery of the top core 65. A groove 66d accommodating the annular elastic member 68 is formed in the outer circumferential surface of each inner circumferential pressing member 66. The groove 66d extends in the circumferential direction. Preferably, the annular elastic member 68 is accommodated in the groove 66d in a state where tension is exerted with the diameter thereof slightly increased as compared with a natural state. For this reason, a radially inward force from the annular elastic member 68 is applied at all times to the inner circumferential pressing member 66. For example, as the annular elastic member 68, a general 0 ring can be diverted as a seal material.

A drive shaft 69 is disposed on the axis L6 of the core 61F. The drive shaft 69 is inserted into the top core 65 through the base core 64. The tip portion of the drive shaft 69 is a tapered portion 69e that has a tapered shape. The material of the drive shaft 69 is a hard resin and is preferably PEEK.

A conical recessed surface-shaped cam surface 65e is formed on the inner circumferential surface of the top core 65. The cam surface 65e of each inner circumferential pressing member 66 has a half conical recessed surface shape. The tapered portion 69e abuts against the cam surface 65e.

The tapered portion 69e and the cam surface 65e constitute a cam mechanism. In other words, the cam mechanisms 69e and 65e are provided between the drive shaft 69 and the inner circumferential pressing member 66.

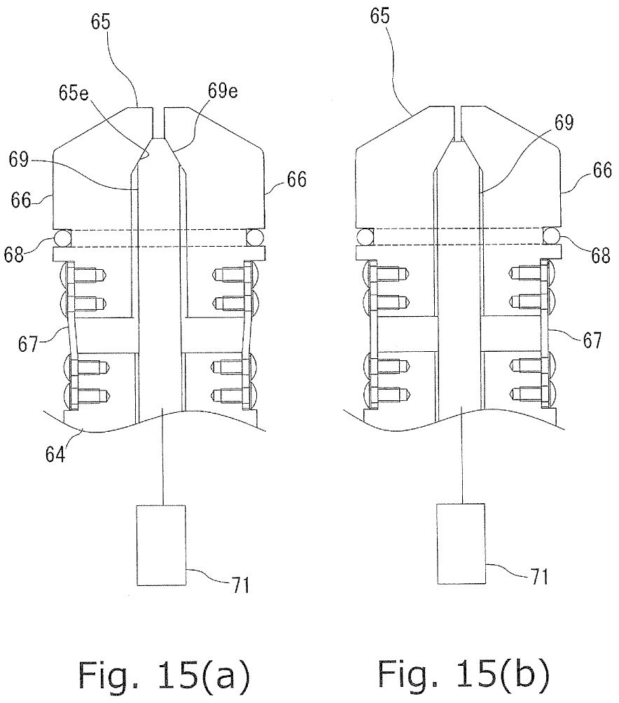

As illustrated in FIG. 15, the drive shaft 69 can be displaced so as to ascend and descend between an upward advanced position and a downward retracted position along the axis L6 by a shaft drive unit 71 such as an air cylinder.

As illustrated in FIG. 15(a), when the drive shaft 69 is raised to the advanced position, the inner circumferential pressing member 66 is pushed radially outward by the cam action of the tapered portion 69e and the cam surface 65e. Accordingly, the diameter of the top core 65 increases. In conjunction therewith, the connecting plate 67 is elastically deformed such that the end portion of the connecting plate 67 on the top core 65 side warps outward. The annular elastic member 68 is elastically deformed in a diameter-increasing direction.

Note that, in FIG. 15(a), the degree to which the diameter of the top core 65 increases is exaggerated.

As illustrated in FIG. 15 (b), once the drive shaft 69 is lowered to the retracted position, the inner circumferential pressing member 66 is pressed radially inward and retracts to its original position due to the elastic restoring force of the leaf spring-shaped connecting plate 67 and the annular elastic member 68. As a result, the top core 65 is reduced in diameter to return to its original normal diameter.

The drive shaft 69, the shaft drive unit 71, the connecting plate 67, and the annular elastic member 68 constitute core driver. Furthermore, the connecting plate 67 and the annular elastic member 68 constitute inner circumferential urging means.

As illustrated in FIGS. 12 and 13, three (a plurality of) outer circumferential pressing members 62 are provided on the outside of the tip portion of the core 61F. The outer circumferential pressing members 62 have the shape of a partial cylinder in which a covered cylinder is divided into three pieces. The three outer circumferential pressing members 62 surround the top core 65 from three sides. Each outer circumferential pressing member 62 can be radially advanced and retracted by an outer circumferential presser drive unit 72 such as an air cylinder. Preferably, the three outer circumferential pressing members 62 are advanced and retracted synchronously with each other. The material of the outer circumferential pressing member 62 is a hard resin. From the viewpoint of heat resistance, insulating properties, and lubricity, the material is preferably PEEK.

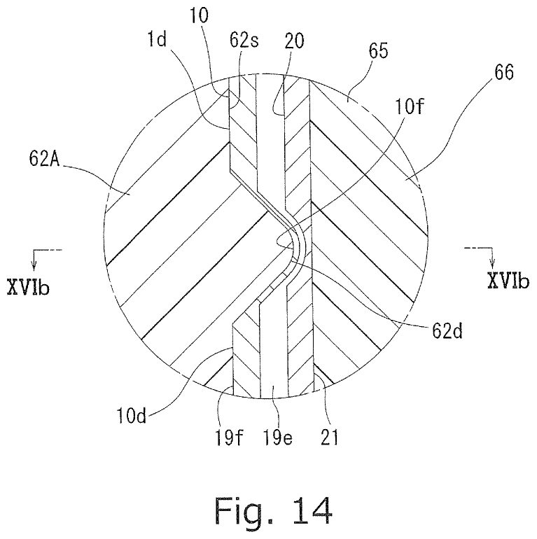

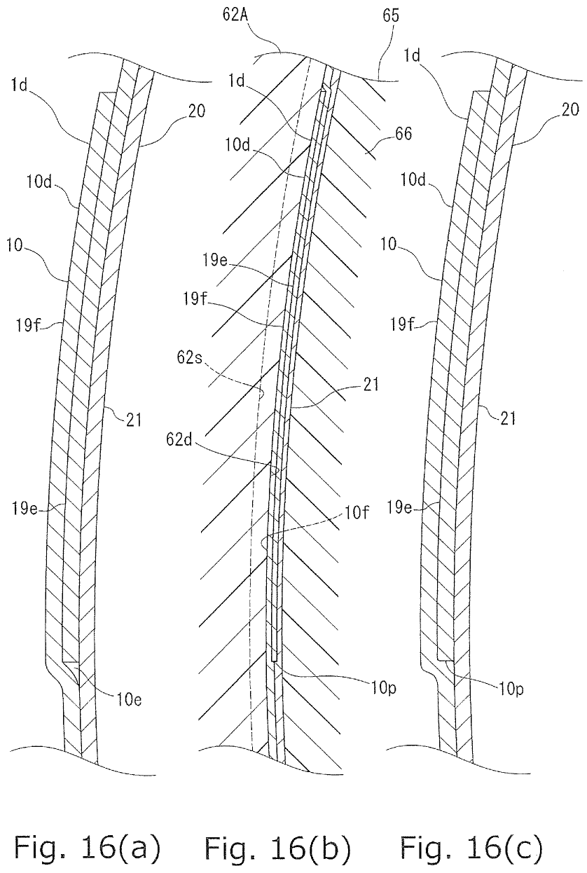

As illustrated in FIG. 14, a projection 62d is formed on an inside surface 62s (surface facing the top core 65) of a single outer circumferential pressing member 62A, which is one of the outer circumferential pressing members 62. As illustrated in FIG. 16(b), the projection 62d extends in the circumferential direction of the inside surface 62s. As illustrated in FIG. 14, a cross section orthogonal to the extending direction of the projection 62d has a substantially triangular shape, and the top portion thereof is R-chamfered and smooth. The protruding height of the projection 62d exceeds one time of the thickness of the body portion sheet 19. Preferably, the protruding height exceeds two times of the thickness of the body portion sheet 19 and is smaller than the total of two times of the thickness of the body portion sheet 19 and the thickness of the tip sheet member 20.

As illustrated in FIG. 12, a high-frequency induction heating coil constitutes the welding head 63. The welding head 63 surrounds the three outer circumferential pressing members 62 and, in turn, surrounds the outer periphery of the top core 65.

<Soft Container Manufacturing Method>

A method for manufacturing the soft container 1F will be described below, focusing on a method for joining the body portion 10 and the tip sheet member 20.

The body portion 10 and the tip sheet member 20 are separately prepared. Preferably, the body portion 10 and the tip sheet member 20 are prepared such that a certain clearance (gap attributable to a dimensional difference) is formed between the tip portion of the body portion 10 and the circumferential side portion 21 of the tip sheet member 20.

The discharge port member 30 is joined to the tip sheet member 20. Preferably, the discharge port member 30 is injection-molded on a resin sheet material simultaneously with drawing of the tip sheet member 20 on the resin sheet material. As a result, the discharge port member 30 and the tip sheet member 20 are integrally joined simultaneously with molding of the discharge port member 30 and the tip sheet member 20.

The tip sheet member 20 that has the discharge port member 30 and the body portion 10 are sent to the high-frequency welding device 60F.

In the high-frequency welding device 60F, the drive shaft 69 is set to the retracted position and the top core 65 is set to a normal diameter. In addition, the outer circumferential pressing member 62 and the welding head 63 are retracted.

Then, the tip of the core 61F is covered with the tip sheet member 20 that has the discharge port member 30.

Subsequently, the outer periphery continuous below the tip of the core 61F is covered with the body portion 10. On the outer periphery of the top core 65 (on the outer periphery near the tip of the core 61F), the tip portion of the body portion 10 is overlapped on the outer circumferential side of the circumferential side portion 21 of the tip sheet member 20.

By the top core 65 being set to the normal diameter, the core 61F can be reliably covered with the tip sheet member 20 and the body portion 10. In addition, by the clearance being provided between the tip portion of the body portion 10 and the circumferential side portion 21 of the tip sheet member 20, the outer periphery of the circumferential side portion 21 of the tip sheet member 20 can be easily covered with the tip portion of the body portion 10. Breaking of the body portion 10 during the covering with the body portion 10 can be prevented.

The envelope pasting portion 10d of the body portion 10 faces the outer circumferential pressing member 62A that has the projection 62d.

Subsequently, the outer circumferential pressing member 62 and the welding head 63 are set to the prescribed positions illustrated in FIG. 12.

As illustrated in an enlarged manner in FIG. 16 (a), in this stage, there is a case in which a pasting portion inner gap 10e is formed in the envelope pasting portion 10d at the overlapping part 1d between the body portion 10 and the tip sheet member 20. The pasting portion inner gap 10e is defined by the end surface of the inside sheet end portion 19e, the inner surface of the outside sheet end portion 19f, and the outer circumferential surface of the tip sheet member 20. The pasting portion inner gap 10e extends in a direction orthogonal to the page of FIG. 16 (a) along the end surface of the sheet end portion 19e. The lower end portion of the gap 10e (back of the page of FIG. 16 (a)) is connected to the inner space of the body portion 10 at the height of the lower end of the circumferential side portion 21. The upper end portion of the gap 10e (front of the page of FIG. 16 (a)) is connected to the outside at the height of the upper end of the body portion 10.

Next, the drive shaft 69 is set to the advanced position, and then the diameter of the top core 65 increases. As a result, the circumferential side portion 21 of the tip sheet member 20 is expanded from the inner circumferential side by the top core 65 including the two inner circumferential pressing members 66.

Further, the three outer circumferential pressing members 62 are elastically urged radially inward from three directions by the outer circumferential presser drive unit 72 such as an air cylinder.

As a result, the overlapping part 1d between the circumferential side portion 21 of the tip sheet member 20 and the tip portion of the body portion 10 is strongly pinched between the outer circumferential pressing member 62 and the inner circumferential pressing member 66 over the entire circumference. As a result, the circumferential side portion 21 of the tip sheet member 20 and the tip portion of the body portion 10 are brought into tight contact over the entire circumference, and the clearance is eliminated.

Further, as illustrated in FIGS. 14 and 16 (b), the inside surface 62s of the single outer circumferential pressing member 62A faces the envelope pasting portion 10d of the body portion 10. Further, the projection 62d of the inside surface 62s bites into the overlapping part 1d between the body portion 10 and the tip sheet member 20 so as to cross the envelope pasting portion 10d, the pasting portion inner gap 10e in turn. At apart 10f bitten into by the projection 62d, the body portion 10 and the tip sheet member 20 are strongly compressed. As a result, the pasting portion inner gap 10e is locally crushed at an intersecting part 10p with respect to the projection 62d.

In this state, a high-frequency current is supplied to the high-frequency induction heating coil of the welding head 63. As a result, each of the metal barrier layers of the body portion 10 and the tip sheet member 20 on the outer periphery of the top core 65 is heated. In other words, welding energy is supplied from the welding head 63 onto the outer periphery of the top core 65. As a result, the resin layers of the body portion 10 and the tip sheet member 20 on the outer periphery are heated and melted, and the body portion 10 and the tip sheet member 20 are welded.

The soft container 1F is manufactured in this manner.

As described above, the clearance between the tip sheet member 20 and the body portion 10 is eliminated over the entire circumference, and thus the tip sheet member 20 and the body portion 10 can be firmly welded and joined over the entire circumference. As a result, it is possible to prevent a gap attributable to the clearance from being formed in the completed soft container 1F.

Furthermore, the pasting portion inner gap 10e is locally crushed at the part 10p intersecting with the projection 62d, and thus the pasting portion inner gap 10e can be blocked by the local part 10p being welded. Specifically, as illustrated in FIG. 16(c), at the local part 10p, for example, the sheet end portion 19f is deformed along the end surface of the sheet end portion 19e and firmly welded to the end surface, eliminating a gap. Accordingly, the pasting portion inner gap 10e is divided at the local part 10p. As a result, it is possible to avoid communication between the inner space of the soft container 1F and the outside through the pasting portion inner gap 10e. As a result, it is possible to prevent the content in the soft container 1F from leaking out through the pasting portion inner gap 10e and outside air from entering the soft container 1F through the pasting portion inner gap 10e.

In addition, the diameter dimension of the overlapping part 1d between the tip sheet member 20 and the body portion 10 can be stabilized by the outer circumferential pressing member 62, and thus the dimensional accuracy of the soft container 1F can be enhanced.

After the welding process described above, the drive shaft 69 is retracted downward and the inner circumferential pressing member 66 is retracted radially inward by the elastic restoring force of the connecting plate 67 and the annular elastic member 68. Then, the top core 65 returns to its original normal diameter.

In addition, the outer circumferential pressing member 62 and the welding head 63 are retracted.

Then, the soft container 1F is pulled out upward from the core 61F and taken out. By the body portion 10 and the circumferential side portion 21 of the tip sheet member 20 being formed in a tapered shape that is slightly tapered, the pulling operation from the core 61F can be facilitated.

<Butt-Seamed Soft Container 1G>

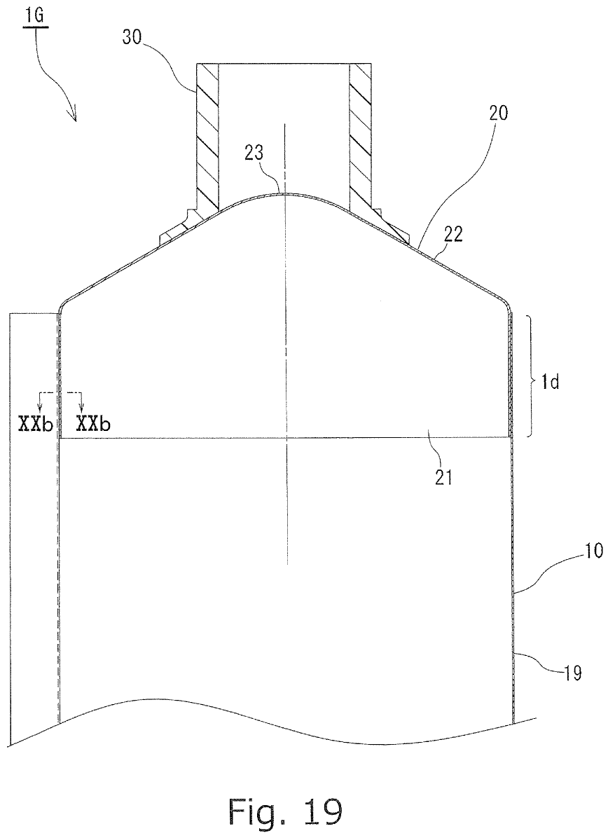

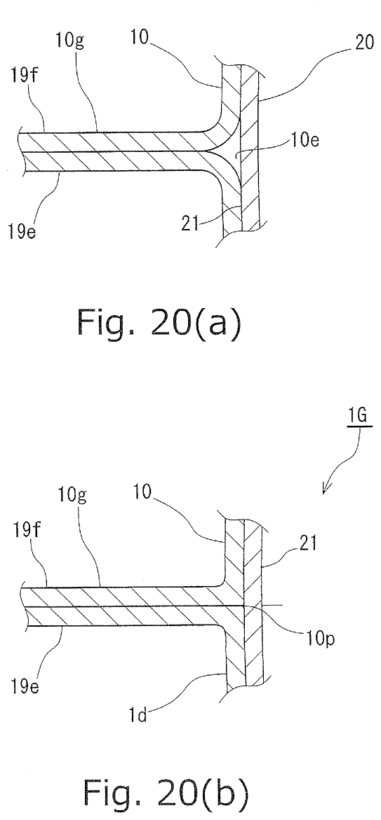

FIGS. 19 and 20 illustrate a modified example of the soft container.

As illustrated in FIG. 19, in the soft container 1G, both end portions 19e and 19f of the sheet 19 constituting the body portion 10 are butt-seamed. For this reason, as illustrated in FIG. 20(a), in the stage in which the core 61F is covered with the tip sheet member 20 and the body portion 10, the pasting portion inner gap 10e is formed in between the space between the bases of both end portions 19e and 19f and the outer circumferential surface of the circumferential side portion 21 of the tip sheet member 20.

Subsequently, the overlapping part 1d between the body portion 10 and the tip sheet member 20 is pinched by the top core 65 and the outer circumferential pressing member 62, the projection 62d crosses a butt-seamed portion 10g, and the overlapping part 1d is bitten into. Then, the pasting portion inner gap 10e is crushed. The overlapping part 1d is welded in this state. As a result, the pasting portion inner gap 10e can be blocked as illustrated in FIG. 20 (b).

The present invention is not limited to the above-described embodiments, and various modifications can be made within scopes not departing from the gist thereof.

For example, the top portion 23 may be flat.

Self-supporting properties may be ensured by selection of, for example, the thickness, the material, and the like of the resin layer of the sheet molded body 28.

The plurality of embodiments may be combined with each other. For example, the bottom sheet member 40 of the fourth embodiment (FIGS. 8 to 9) may be applied to the second embodiment (FIGS. 5 to 6) or the third embodiment (FIG. 7). The tip extending portion 11 of the fifth embodiment (FIG. 10) may be applied to the second embodiment (FIGS. 5 to 6) or the third embodiment (FIG. 7).

The film structure, material, and manufacturing method pertaining to the body portion 10 and the tip sheet member 20 can be appropriately modified. Although high-frequency welding is used as a method for joining between the circumferential side portion 21 of the tip sheet member 20 and the body portion 10, joining methods are not necessarily limited thereto and other welding methods such as ultrasonic welding and thermal welding may be used. The outer circumferential surface of the tip portion of the body portion 10 may be covered with the circumferential side portion 21 of the tip sheet member 20 for joining between the outer circumferential surface and the circumferential side portion 21. The overlapping part 1d may be welded by the core being heated and the heat being transferred to the overlapping part 1d on the outer periphery of the core.

The outer circumferential pressing member may be an annular body not divided into a plurality of parts. The outer circumferential pressing member may be omitted. The projection 62d of the outer circumferential pressing member may be omitted.

### INDUSTRIAL APPLICABILITY

The present invention can be applied as, for example, a discharge gun cartridge for a viscous body or a fluid such as an adhesive and a paint.

### REFERENCE SIGNS LIST

1, 1B, 1C, 1D, 1E, 1F, 1G Soft container
9 Accommodated object
10 Body portion
11 Tip extending portion
19 Sheet
20 Tip sheet member
21 Circumferential side portion
22 Shoulder portion
23 Top portion
28 Film molded body
29 Blank film (pre-molding film)
30, 30C Discharge port member
39 Molten resin (material of discharge port member)
40 Bottom sheet member
41 Circumferential side portion
42 Shoulder portion
43 Top portion
48 Second film molded body
50 Molding apparatus (soft container manufacturing apparatus)
50b Sheet molding unit
50c Discharge port molding unit
50d Cavity
51b Drawing die portion
60F High-frequency welding device (soft container manufacturing apparatus)
61F Core
62 Outer circumferential pressing member
62A Single outer circumferential pressing member
62d Projection
62s Inside surface
63 Welding head
65 Top core (core part)
66 Inner circumferential pressing member
67 Connecting plate
68 Annular elastic member
69 Drive shaft
71 Air cylinder (shaft drive unit)
72 Air cylinder (outer circumferential presser drive unit)

1. A soft container comprising:
a flexible body portion; and
a tip sheet member blocking a tip portion of the body portion,
wherein a self-supporting film molded body having a uniform thickness constitutes the tip sheet member and the film molded body integrally has:
a tubular circumferential side portion joined to the body portion;
a shoulder portion reduced in diameter in a tapered shape from the circumferential side portion toward a tip side; and
a top portion blocking a tip portion of the shoulder portion.

2. The soft container according to claim 1, further comprising a bottom sheet member blocking a bottom portion of the body portion,
wherein the bottom sheet member has substantially the same shape as the tip sheet member and can be fitted into the tip sheet member.

3. The soft container according to claim 1, wherein a tip side part of a sheet constituting the body portion constitutes a tip extending portion by extending to the tip side beyond the tip sheet member and a tip portion of the tip extending portion is sealed.

4. The soft container according to claim 1, wherein a tubular or annular discharge port member is joined to an outer surface of a shoulder portion of the tip sheet member and an outer diameter of the discharge port member is smaller than an inner diameter of the tip portion of the body portion.

5. A soft container manufacturing apparatus for manufacturing the soft container according to claim 4, comprising:
a sheet molding unit including a projecting drawing die portion and drawing the tip sheet member from a blank film; and
a discharge port molding unit facing the drawing die portion, defining a cavity with the tip sheet member on the drawing die portion, and injection-molding the discharge port member by injecting a material of the discharge port member to the cavity.

6. A soft container manufacturing method for manufacturing the soft container according to claim 4, comprising:
drawing the tip sheet member from a blank film by a sheet molding unit; and
injecting a material of the discharge port member to a cavity defined between the tip sheet member held by the sheet molding unit and a discharge port molding unit facing a tip side of the tip sheet member.

7. A soft container manufacturing apparatus for joining a circumferential side portion of a tip sheet member to the tip portion of the body portion of the soft container according to claim 1, comprising:
a core having a tip covered with the tip sheet member and having an outer periphery continuous with the tip and covered with the body portion, the circumferential side portion of the tip sheet member and the tip portion of the body portion overlapping each other on the outer periphery near the tip;
core driver increasing a diameter of a core part of the core near the tip during the joining; and
a welding head supplying welding energy onto the outer periphery of the core part.

8. The soft container manufacturing apparatus according to claim 7,
wherein the core part has a plurality of inner circumferential pressing members disposed so as to be separated in a circumferential direction, and
the core driver advances and retracts the plurality of inner circumferential pressing members in a radial direction of the core.

9. The soft container manufacturing apparatus according to claim 7, further comprising an outer circumferential pressing member surrounding the outer periphery of the core part.

10. The soft container manufacturing apparatus according to claim 9, wherein a projection extending in the circumferential direction is formed on a surface of the outer circumferential pressing member facing the core part.
